(19) United States
(12) Patent Application Publication
(10) Pub. No.: US 2013/0166338 A1
(43) Pub. Date: Jun. 27, 2013

(54) ENHANCED BUSINESS PLANNING AND OPERATIONS MANAGEMENT SYSTEM

(71) Applicants: RALF PHILIPP, Altlussheim (DE); Moran Shwartz, Bnei Ayish (IL)

(72) Inventors: RALF PHILIPP, Altlussheim (DE); Moran Shwartz, Bnei Ayish (IL)

(21) Appl. No.: 13/334,120

(22) Filed: Dec. 22, 2011

(51) Int. Cl. G06Q 10/06

(52) U.S. Cl. 705/7.13

(57) ABSTRACT

In one embodiment, the method includes receiving one or more criteria defined as a planning trigger. In a further aspect, the method includes mapping the one or more criteria to a corresponding action plan. In response to recording criterion defined as a planning trigger, an action plan corresponding to the recorded criterion is invoked. Further, the method includes communicating the action plan to a selected set of contributors. Further, the method involves, receiving data specified in the action plan from the set of contributors and consolidating the business data received from the one or more contributors. In a further aspect, the method involves, extrapolating the received business data for generating extrapolated business data for one or more prognostic scenarios for facilitating business planning and operations.

### FIELD

The field relates generally to integrated business management systems. More specifically, the field relates to automated collection and processing of business information for optimizing business operations in an integrated business management system.

### BACKGROUND

Business planning and performance monitoring has become extremely important in today's business marketplace in making optimized operational plans and decisions. Also, banks, corporations, credit companies, insurers and other underwriters have a need to monitor business performance information of their customers in order to minimize risk and avoid financial surprises. Moreover, the stability of manufacturing and service providing companies is often dependent on one or more key processes or operations. As a result, manufacturing and service companies have a need to review business performance information from time to time, in an ongoing fashion, in order to insure that their future business operations remain stable.

Companies implementing or operating integrated planning and control systems have realized the benefits of formalizing and integrating business planning processes. Typically, a business planning process involves gathering and monitoring business performance information followed by a periodic review process by top management of all functional areas of the company. Its ultimate goal is to always keep the detailed sales, manufacturing, purchasing and capacity planning systems in synchronization with the latest high level plans of management (the business plan). Unfortunately, the process of gathering and monitoring business performance information on businesses has been highly labor intensive and often produced inaccurate results. Another problem with conventional data gathering processes is that the data collection method may be disjointed, consisting of various sources which must be manually assimilated into a format that is valuable to consumers of such information. This is a labor intensive process which increases the ultimate cost for such information and likely reduces its accuracy. Further, the data gathering process becomes all the more time consuming if the impact of a change by one contributor has to be evaluated manually by other contributors through multiple iterations.

Further, sudden developments in the socio-economic conditions surrounding business operations may require immediate changes to certain business operations. In order to effect such changes, the business performance information and other statistical data may need to be revisited by the decision makers. However, the business information gathering process may not be initiated unless directed by management personnel leading to untimely planning and execution of operations. Another challenge accompanying traditional business management systems is the lack of an automated system to facilitate consensus on a business plan among various functional units.

### SUMMARY

Various embodiments of systems and methods for automated collection and processing of business information for optimizing business operations in an integrated information management system are described herein. In one aspect, a method for facilitating business planning and operations involves receiving one or more criteria relating to a business, defined as a planning trigger. In a further aspect, the method includes mapping the one or more criteria to an action plan. According to one embodiment, the planning trigger is actuated in response to recording at least one criterion of the one or more criteria. In a further aspect, the method includes invoking an action plan corresponding to the at least one criterion, in response to the actuation of the planning trigger. The action plan is then notified to one or more contributors, based on instructions provided in the action plan. In yet another aspect, the method involves, receiving data specified in the action plan from the one or more contributors and consolidating the business data received from the one or more contributors. In an aspect, the method involves, extrapolating the received business data for one or more prognostic scenarios and generating a business report for the one or more prognostic scenarios based on the extrapolation.

These and other benefits and features of embodiments of the invention will be apparent upon consideration of the following detailed description of preferred embodiments thereof, presented in connection with the following drawings.

### BRIEF DESCRIPTION OF THE DRAWINGS

The claims set forth the embodiments of the invention with particularity. The invention is illustrated by way of example and not by way of limitation in the figures of the accompanying drawings in which like references indicate similar elements. The embodiments of the invention, together with its advantages, may be best understood from the following detailed description taken in conjunction with the accompanying drawings.

FIG. 1 is a flow diagram of a method for automated collection and processing of business information, according to one embodiment.

FIG. 2 is a block diagram of an exemplary system for automated collection and processing of business information for optimizing business operations, according to one embodiment.

FIG. 3 illustrates an action plan rendered on a graphical user interface of a computer, in accordance with an embodiment.

FIG. 4 illustrates a planning interface for receiving business information from one or more contributors, in accordance with an embodiment.

FIG. 5 illustrates a block diagram of an exemplary computer system configured in accordance with an embodiment.

### DETAILED DESCRIPTION

Embodiments of techniques for automated collection and processing of business information for optimizing business operations in an integrated information management system are described herein. In the following description, numerous specific details are set forth to provide a thorough understanding of embodiments of the invention. One skilled in the relevant art will recognize, however, that the invention can be practiced without one or more of the specific details, or with other methods, components, materials, etc. In other instances, well-known structures, materials, or operations are not shown or described in detail to avoid obscuring aspects of the invention.

Reference throughout this specification to “one embodiment”, “this embodiment” and similar phrases, means that a particular feature, structure, or characteristic described in connection with the embodiment is included in at least one embodiment of the present invention. Thus, the appearances of these phrases in various places throughout this specification are not necessarily all referring to the same embodiment. Furthermore, the particular features, structures, or characteristics may be combined in any suitable manner in one or more embodiments.

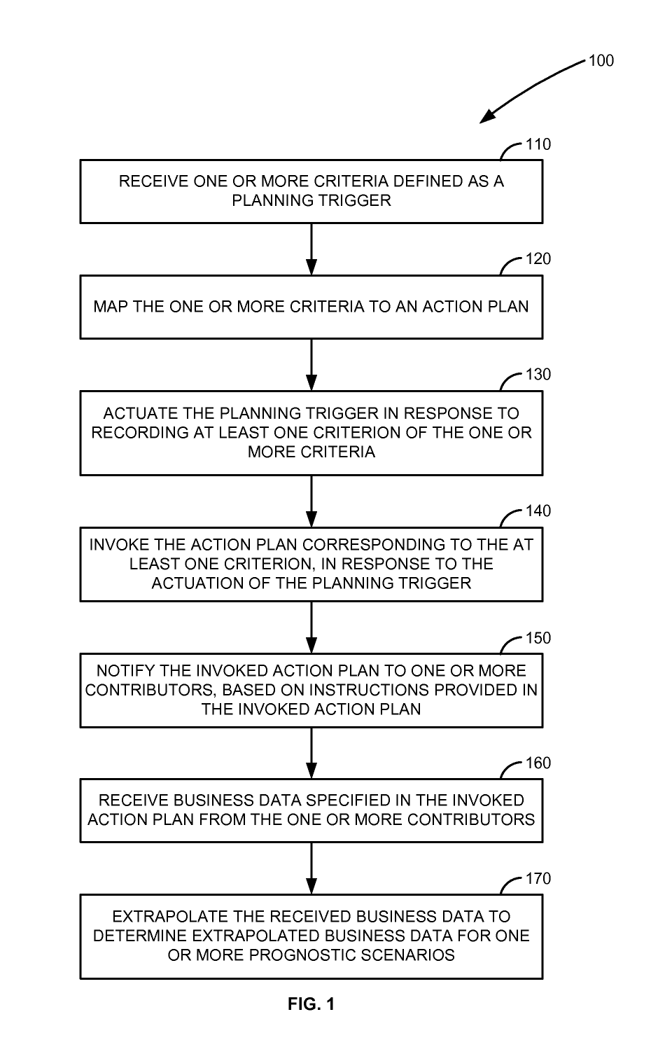

FIG. 1 illustrates a flow diagram of a method 100 for automated collection and processing of business information for optimizing business operations, according to an embodiment. The method 100 is preferably implemented by a computer in an integrated information management system. In an embodiment, the integrated information management system is an on-demand integrated business management solution in which software and associated data are hosted centrally, e.g., on the Internet and accessed by a computer using a web browser. In another embodiment, the integrated information management system is an Enterprise Resource Planning (ERP) system having a plurality of business systems which are integrated to each other over a communication network. Further, the ERP system is enabled with automated pull mechanisms allowing real-time processing and execution of inspection data. As used herein the term “real-time” refers to a time frame that is brief, appearing to be immediate or near concurrent. When the computer processes data in real time, it reads and handles data as it is received, producing results with little delay.

The method 100 includes receiving (110) one or more criteria defined as a planning trigger. The one or more criteria refer to a business related event that is recorded within the integrated information management system. Examples of the one or more criteria recorded in the system include a scheduled business operations review, strategy planning, business report review, goal setting meet, inventory control, production control, supplier evaluation, material requirements planning, marketing promotions planning, demand forecast, sales forecast, revenue planning, resources planning, financial forecast, new business opportunities, and socio-economic developments. The method further includes mapping (120) the one or more criteria to an action plan. The action plan comprises specification relating to business information gathering procedures which includes a customized list of contributors of business data and associated roles, particulars of business data required from each of the contributors, a defined format for rendering business data, a defined timeline for providing business data by the contributors, and a meeting agenda. The action plan may further include instructions for: identifying the one or more contributors, defining a format for receiving business information, defining the type of data required from the one or more contributors, setting a timeline for receiving data, and the like. If it is detected that at least one criterion that has been configured as a planning trigger is recorded in the system, the planning trigger is automatically actuated (130) unless an override feature is enabled. In response to the actuation of the planning trigger, the method includes automatically invoking (140) an action plan corresponding to the at least one criterion that actuated the planning trigger. For example, the method may refer to a data file or a mapping table stored in the system that contains a mapping of each of the one or more criteria to a respective action plan and then invokes the action plan associated with the criteria that actuated the planning trigger. The mapping between the one or more criteria and an action plan may be performed during an initial set up of the system, at the beginning of the financial year, or at any scheduled cycle. In another aspect, the mapping table is maintained as an active file, in which new criteria and associated action plans can be dynamically added to the table from time to time.

In an example, the growth in GDP for a certain region where the business has market shares may be configured as a planning trigger. When such a criterion is recorded in the system, the planning trigger is actuated and a corresponding action plan is invoked using the mapping from the mapping table. In the given example, the action plan may specify the strategy to be followed for performing business operations in that region in terms of production, pricing, distribution, and the like. In addition, the action plan may include particulars of the contributors associated with the business operations for this region, the business information required from each of the contributors, the format in which data is to be received from the contributors, the timeline by which the business information is to be received. The format for collecting data may include standardized units of measure, currency, syntax, date format, data representation format, data presentation format, standardized codes, and the like.

The term “contributor” as used herein refers to a representative (person or system) of a functional area of a business, possessing business information relating to the functional area. Examples of a contributor include management personnel, automated database systems, a business head, subject matter expert, market research agency, and the like. The functional area as used herein refers to a segment or a logical element of a company representing a specific business function. Example of a functional area includes Finance & Accounting, Sales and Marketing, Human Resources, Supply Chain and Logistics, and Production. The term “business information” as used herein refers to various operational and/or financial information gathered from various departments, divisions, and business locations and is often reviewed by the management of a business to make business decisions regarding operational improvements and reviewing new business opportunities. Examples of business information include market intelligence data, forecast data, statistical data, balance sheet, and numerical data relating to: cash flow, production, targets, profit, income, margins, costs, sales, inventories, purchase, budget, and other recorded transactions. The term “business operations” as used herein refers to ongoing recurring activities involved in running a business for the purpose of producing value from the assets owned by the business. The term “planning trigger” as used herein refers to one or more computational steps that are automatically executed by a computer in response to events recorded in the system. The term “socio-economic development” as used herein refers to the process of social and economic development in a society. Socio-economic development is measured with indicators such as GDP, life expectancy, literacy, and employment levels. Causes of socio-economic impacts are, for example, new technologies, changes in law, changes in the physical environment, and ecological changes. Other examples of socio-economic developments include change in export control measures, demographics, health services, population, and the like.

Referring back to FIG. 1, the method includes notifying (150) the action plan to the one or more contributors, based on instructions provided in the action plan. In an aspect, notifying the action plan to the one or more contributors includes communicating the action plan to the one or more contributors based on the instructions provided in the action plan. Based on the particulars of the contributors provided in the action plan, the action plan may be automatically communicated by any electronic or digital means to the identified contributors at a predefined time. For example, the action plan may be communicated to a communication device associated with the contributors as an electronic meeting request, an email communication, a voice message, a short message service, pager, and the like. The action plan may be communicated to the contributors within a set period such as within two business hours from the time of recording the event. In an aspect, in response to receiving the action plan, the contributors may provide the business information required of them, including inputs to the one or more prognostic scenarios specified in the action plan. Examples of business information include any business data representative of the current business operations and performance status of a business.

In an embodiment, the action plan may include a template for receiving business information where the attributes of the template is customized for each of the contributors according to the business information required from each of the contributors. In another embodiment, the contributor may import a document holding the required business information. In another aspect the contributor may invoke the business information that was put together at a previous instance and update the information based on the current status and according to the requirements specified in the action plan. Further, the method includes receiving (160) the business information from the one or more contributors through electronic or digital means and consolidating the received business information. In an example, the business information received from the contributors may be transformed into a standard format and consolidated into a business report.

In an aspect, the method further includes defining prognostic scenarios based on the recorded at least one criterion. The prognostic scenarios refer to “What if?” conditions, which are defined by making certain assumptions on the recorded criterion. In the given example, the growth in GDP for that particular region may be a predictive figure defined by a range of values e.g., 2.3-3.5%. The one or more prognostic scenarios may be determined based on the values 2.3-3.5% such that the one or more prognostic scenarios cover an optimistic scenario of 3.5% or more growth in GDP and a pessimistic scenario of 2.3% or less growth in GDP. The prognostic scenarios are then included in the action plan communicated to the contributors. The contributors may then provide the business information relating to the prognostic scenarios.

In an alternative embodiment, the method includes automatically determining business information relating to the one or more prognostic scenarios based on the statistical data recorded in the system for a similar scenario in the past. The method may employ heuristic algorithms or linear equations to derive perceived values for the prognostic scenarios. For example, for an assumed GDP growth of 2.3% in Latin America, the system may retrieve historical data relating to a GDP growth of around 2.5% in Latin America. The historical data may include information regarding the market growth in Latin America, the no. of sold goods in that region, the then pricing of the goods, and the assigned profit margins. Based on applying heuristics to such historical data, the method may determine certain values for business information for the current prognostic scenario of 2.3% growth in GDP for Latin America. For example, the method may determine the no. of goods that can be sold in Latin America, expected market growth, profit margin, production volume, promotions, and the like for the prognostic scenario of 2.3% growth in GDP. Similarly, the business values for other prognostic scenarios can be derived using a similar approach.

In another embodiment, the business information for the prognostic scenarios may be determined based on the business information received from the one or more contributors relating to the current business operations. For example, the received business information that represents the current operational scenario of the company can be extrapolated (170) (i.e., projected or extended) based on statistical data relating to business plans executed in the past, in order to derive data relating to the one or more prognostic scenarios. In the given example, the business information, relating to the current business operations for the region predicted to have a GDP growth in the range of 2.3-3.5%, may be extrapolated to derive business information for the pessimistic scenario (2.3% or less) and optimistic scenario (3.5% or more). The business information relating to the current business operations may include data relating to: financial statements, budgets, operating cash-flow, investments, production schedules, planned production volume, actual manufacturing capacity, market demand, pricing, product life-cycle, customer orders, inventory, and the like. The contributors of such business information include various business functions such as Production, Finance, Procurement, Sales & Marketing. Also, data relating to governing bodies, standards, and law such as tax authorities, national insurance and welfare agencies, defense departments, economic organizations, immigration authorities, customs, export control authorities, and the like may be accessed from external data source systems. In an embodiment, the method employs statistical-simulation models for extrapolating the available business information relating to the current business operations.

In a further embodiment, the method includes proposing an optimal consensus plan based on the consolidated business report. The optimal consensus plan refers to an optimal of all possible consensus plans. In an embodiment, the optimal consensus plan is generated based on the business objective defined by certain financial and operational Key Performance Indicators (KPIs). Examples of KPIs include profit margin, revenue, business objective, strategic goals, operating income, and the like. In an example, the optimal consensus is proposed by evaluating/matching the consensus plan to KPIs according to a weight assigned to each KPI, e.g., profit margin over topline growth. The business objective may be defined during a latest planning cycle or at the beginning of a financial year. Alternatively, the KPIs may be keyed into the system at the time of generating the action plan. The optimal consensus plan may be generated so as to match the business objectives. In an aspect, the optimal consensus plan may be generated by solving Linear equations through matrix systems, wherein a business operations model is transformed to matrices having input and output vectors, and solving the matrix. In the given example, the optimal consensus plan may include proposal to increase sales, decrease profit margin, decrease promotions, increase inventory, and increase production for Latin America for the GPD growth between 2.3-3.5%. The proposed consensus plan may be used as a decision support plan for the business personnel to arrive at a business decision.

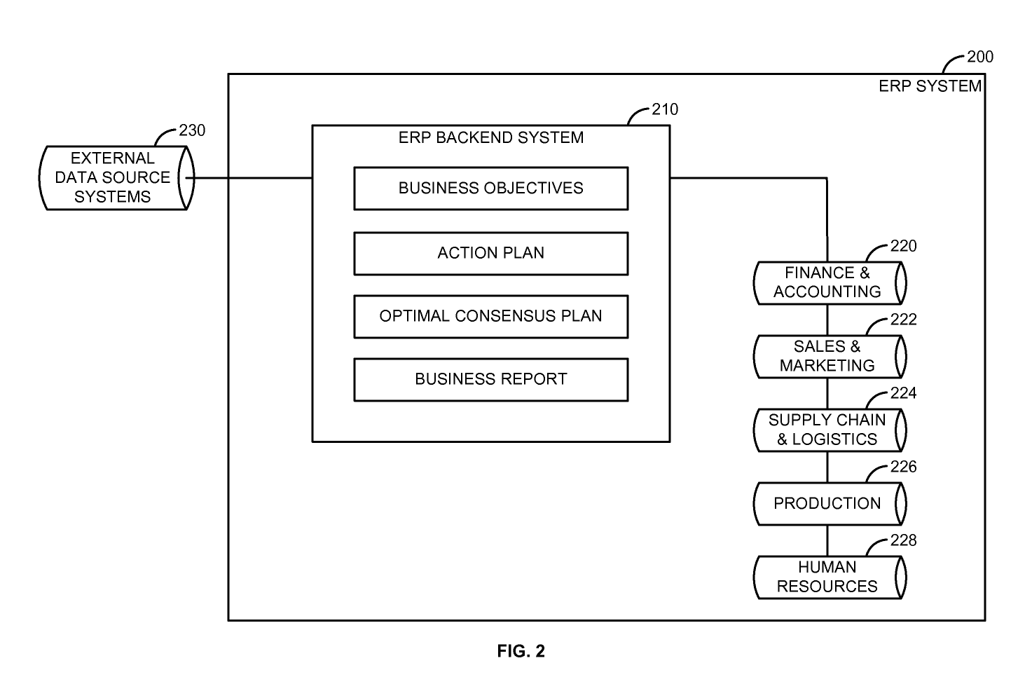

FIG. 2 is a block diagram of an exemplary system for automated collection and processing of business information for optimizing business operations, according to one embodiment. The system 200 includes a backend system 210, one or more business systems 220, 222, 224, 226, 228 and external data source systems 230. In an embodiment, the system 200 is an ERP system integrated over a communication network. The ERP system 200 includes business systems relating to Finance & Accounting 220, Sales & Marketing 222, Supply Chain & Logistics 224, Production 226, and Human Resources 228, integrated to each other over a communication network. Further, the ERP system 200 is enabled with automated pull mechanisms allowing real-time processing and execution of inspection data. As used herein, the term “real-time” refers to a time frame that is brief, appearing to be immediate or near concurrent. When a computer processes data in real-time, it reads and handles data as it is received, producing results without delay. The ERP backend system 210 is a computer operating in communication with the business systems 220, 222, 224, 226, and 228, and external data source systems 230. External data source systems 230 include sources of data that enable data storage and retrieval. For example, data source systems 230 may include databases, such as, relational, transactional, hierarchical, multi-dimensional (e.g., OLAP), object oriented databases, and the like. Data source systems 230 may also include a data source where the data is not tangibly stored or otherwise ephemeral such as data streams, broadcast data, and the like.

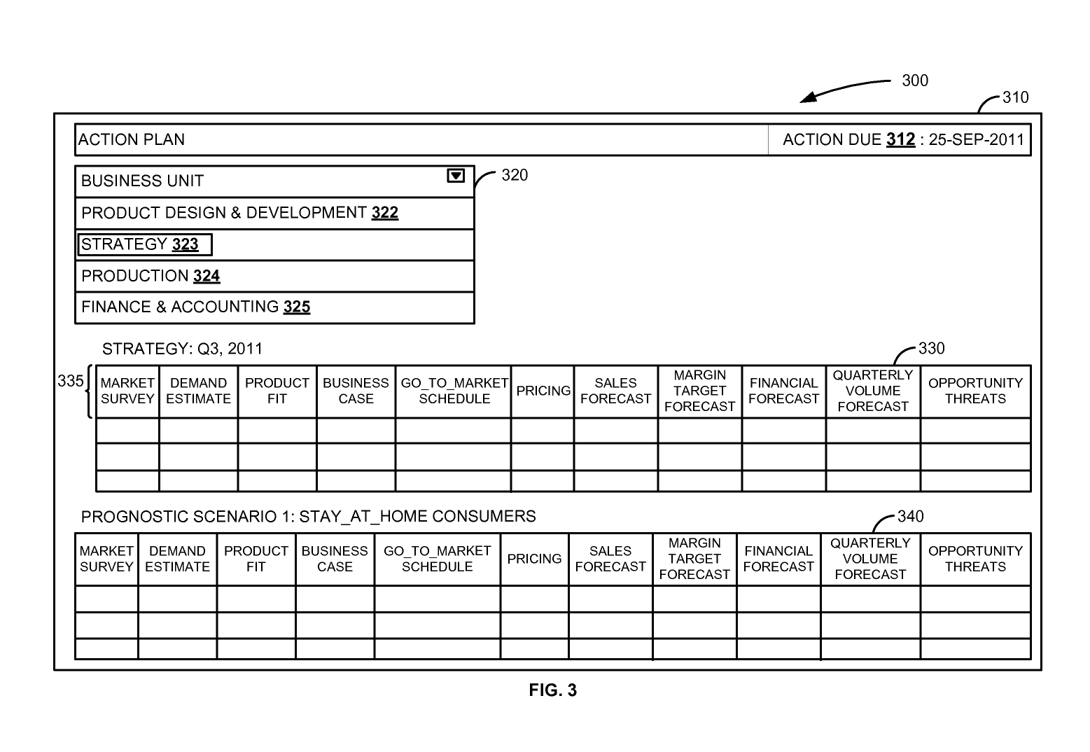

The computer 210 includes a processor (not shown) that executes software instructions or code comprising an optimized business planning tool, stored on a computer readable storage medium, to perform the above-illustrated methods. The computer 210 includes a media reader to read the instructions from the computer readable storage medium and store the instructions in storage or in random access memory (RAM). For example, the computer readable storage medium includes executable instructions for performing operations including, but not limited to, receiving a set of criteria defined as a planning trigger, mapping the one or more criteria to an action plan, actuating a planning trigger in response to recording at least one criterion of the one or more criteria, invoking an action plan corresponding to the criterion that actuated the planning trigger, notifying the action plan to one or more contributors, based on instructions provided in the action plan, receiving business data specified in the action plan from the one or more contributors, extrapolating the received business data to determine extrapolated business data for one or more prognostic scenarios. In an embodiment, the software instructions or code required to perform the above-illustrated methods are accessed as an on-demand software, i.e. Software as a Service (SaaS) over the internet by the computer using a web browser. The business systems relating to Finance & Accounting 220, Sales & Marketing 222, Supply Chain & Logistics 224, Production 226, and Human Resources 228, among others, may each include a computer (not shown) operating on a set of instructions to perform associated functions. The user interface of the computers associated with each of the business systems 220, 222, 224, 226, and 228 may be configured to display the action plan (See FIG. 3) which includes a customized template for rendering business information.

According to an aspect, the computer 210's memory holds a set of criteria relating to business operations that are pre-defined as a planning trigger. The processor upon sensing that a criterion (an event) recorded in the ERP system matches the pre-defined criteria for a planning trigger in the memory actuates a planning trigger. In an example, the set of criteria includes a scheduled business operations review, strategic planning cycle, business performance status review, goal setting meet, inventory control, production control, supplier evaluation, material requirements planning, marketing promotions planning, demand forecast, sales forecast, revenue planning, resources planning, financial forecast, new business opportunities, and socio-economic developments. Further, the computer's memory holds a mapping between each criteria and a respective action plan. In response to the actuation of the planning trigger, the processor invokes an action plan corresponding to the recorded criterion. In an aspect, the action plan may be rendered on a user interface of the computer 210 or any other computer associated with the business systems 220, 222, 224, 226, and 228 of the ERP system 200. In an embodiment, the action plan mapped to a recorded criterion is customized for the contributors of business information relating to the recorded criterion that actuated the trigger. The term “customized” as used herein refers to adapting the attributes of the action plan for each of the one or more contributors. By way of an example, the customized action plan may include information regarding the business information required of each contributor, a format of rendering business information, a time line by which business information is to be provided, and prognostic scenarios for which business information is required.

In an example, an event such as “baby boomers reaching their retirement age” may be configured as a planning trigger. If the processor detects that such an event has been recorded in the system via e.g., a news feed from external database systems or by the one or more business system 220-228, the processor actuates the planning trigger. In response to the planning trigger, the processor invokes the action plan mapped to the baby_boomers_retirement_age event from the mapping table. The invoked action plan may identify the functional areas that may be impacted by this event, the one or more contributors of business information for the identified functional areas, and the business information required of each of the one or more contributors. In an example, the action plan may identify the functional area relating to strategy, sales & marketing, and finance & accounting as the business domains that may be impacted by the recorded event. The instructions provided in the action plan may be founded on marketing strategies that are designed considering that the baby boomers may travel extensively and that they are potential empty nesters. For example, one of the strategies for consumer goods may involve the designing of products that are favorable for travel such as portability & compactness, leak-proof packaging, pressure-resistant packaging, and the like. Similarly, for a food based industry, the strategy might focus on fast and healthy options such as fiber rich & low sugar foods, ready-to-serve meals, Mini packs, and the like. Accordingly, the action plan may identify the relevant functional areas such as Product Design & development, Strategy, Manufacturing, and Finance & accounting. In the given example, the Product Design & Development team may have to consider re-designing the product according to the foreseen needs of the baby boomers, the Strategy team may have to assess the market demand and pricing for the product, the product team may have to assess the production capacity and the inventory, and the budgeting team may have to approve the pricing and production cost.

In an embodiment, using the instructions provided in the action plan for the baby_boomers_retirement_age event, the processor generates a business information (BI) collection template. For example, the template may be customized for each of the identified contributors. In the given example, the BI collection template is customized for each of the functional areas namely Product Design & development, Strategy, Manufacturing, and Finance & accounting. The customized BI collection template may have customized fields for entering the required business information and may include a time line such as one week from the date of communication as the due date for providing the business information. The action plan including the BI collection template may then be communicated to the contributors via an electronic mail service, an electronic meeting notice, a short message service (SMS), a VoIP service, as a voice prompt on a telephone, and the like. The contributors associated with the functional areas receive the customized action plan and provide the business information in the appropriate fields of the BI collection template. Alternatively, the contributors may import a document having the required business information into a business tool that is integrated with the system. The processor upon receiving the business information from the various contributors consolidates the business information into a standard format.

In an embodiment, the processor may define prognostic scenarios based on the baby_boomers_retirement_age event, where the prognostic scenarios may be based on certain aspects such as travelling consumers, stay_at_home consumers, etc. The action plan communicated to the contributors may include the prognostic scenarios such that contributors may provide relevant data for each of the scenarios in addition to the business information relating to the current business operations. Alternatively, the processor may automatically generate business information for the one or more prognostic scenarios based on the received business information relating to the current business operations. The processor may apply extrapolation techniques to derive the business information relating to the prognostic scenarios. The processor may follow any of the extrapolation methods including but not limited to linear extrapolation, polynomial extrapolation, conic extrapolation, French curve extrapolation, etc. The term “extrapolation” as used herein is defined as the process of estimating a value of a variable outside a known range from values within a known range by assuming that the estimated value follows logically from the known values. The processor may also extract business information relating to the prognostic scenarios from the external data source systems. For example, the processor may retrieve market survey information from external analysts or external news feeds and extrapolate that information to determined business data relating to the prognostic scenarios. Examples of market survey information include, market demand, forecast information, consumer spend capacity, spend volumes, etc.

The processor may then project the details of the consolidated business information in a dashboard along with an optimal consensus plan. The consensus plan may be generated based on the business objective defined by certain financial and operational Key Performance Indicators (KPIs). Examples of KPIs include profit margin, revenue, business objective, strategic goals, operating income, and the like. The business objective may be defined during a latest planning cycle or at the beginning of a financial year. Alternatively, the KPIs may be keyed into the system at the time of creating and mapping action plans to one or more events. The optimal consensus plan may be generated so as to match the business objectives. In an aspect, the optimal consensus plan may be generated by solving Linear equations through matrix systems, wherein a business operations model is transformed to matrices having input and output vectors, and solving the matrix.

FIG. 3 illustrates an action plan rendered on a graphical user interface 300 of the computer, in accordance with an embodiment. In the given example, the action plan may be communicated to the one or more contributor as a document or a link, such that selecting the document or the link invokes a dashboard 310 on the graphical user interface 300 of the computer for receiving business information from the contributor(s) associated with the computer. In an example embodiment, the dashboard 310 includes a drop down menu 320 providing a list of business units. Further, the dashboard 310 provides a business information (BI) collection template 330 which may be rendered in response to a selection of a corresponding business unit from the drop down menu 320. In the given example, the drop down menu includes a list of business units such as Product Design & Development 322, Strategy 323, Production 324, and Finance & Accounting 325. As illustrated in FIG. 3, the business unit Strategy 323 is selected (shown highlighted) and a corresponding BI collection template 330 is rendered on the dashboard. The BI collection template 330 includes a header row 335 representing the various Strategy related attributes for which Business information is required from the Strategy team. In the given example, the BI collection template 330 includes parameters such as Market Survey, Demand Estimate, Product Fit, Business Case, Go_to_market schedule, pricing, sales forecast, margin target forecast, financial forecast, quarterly volume forecast, opportunity threats, and the like. The contributor may then populate the fields under each attribute in the template with relevant business information. The business information may be rendered as numerical values, string of characters, alpha-numeric values, or any combination of symbols, characters, numerals, and alphabets. Alternatively, the business information may be provided in the corresponding fields by inserting a link to a document containing the business information in the given field or by importing a document shortcut containing the business information in the give field. The business information may then be extracted by accessing the attached link or document shortcut. The Dashboard 310 may also provide a field 312 specifying a time line by which the business information is to be provided in the template 330. Similarly, a BI collection template 330 may be rendered on the dashboard 310 for each of the other business units 322, 324, or 325 that may be selected. A contributor, upon receiving the action plan communication, may access the relevant business unit 322, 323, 324, or 325 from the drop down menu 320 and invoke a corresponding BI collection template 330 for providing business information.

In an embodiment, if the action plan includes prognostic scenarios, then selecting a business unit may render a planning scenario template for the prognostic scenarios as well. The contributor may then provide the business information relating to the prognostic scenarios in the template planning scenario. In the given example, the dash board 310 includes a BI collection template 340 for one of the prognostic scenario “Stay_at_home consumers.” The “stay_at_home consumers” scenario could be perceived as a pessimistic scenario for a business which manufactures travel accessories, as opposed to an optimistic scenario such as “travelling Consumers” with respect to the “baby_boomers_retirement_age” event.

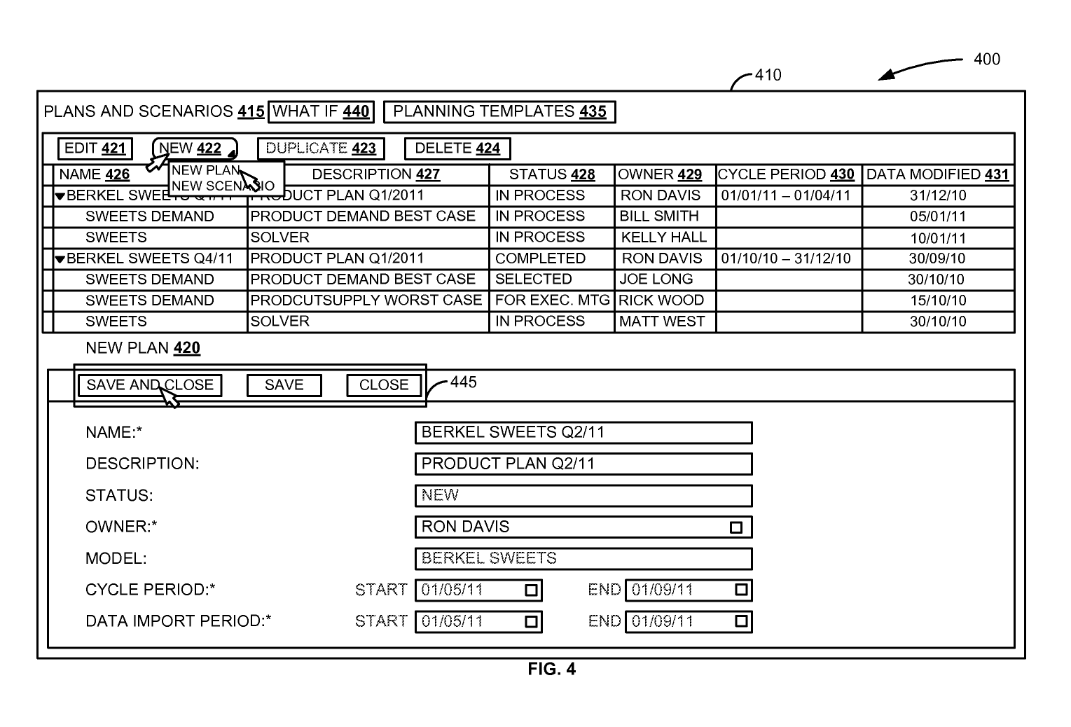

FIG. 4 illustrates a planning interface 410 for receiving business information from one or more contributors, in accordance with an embodiment. In the given example, the process of navigating the planning interface 410 rendered on a graphical user interface (GUI) 400 is illustrated. In this embodiment, in response to receiving an action plan, a contributor may invoke a business planning tool for providing business information. Invoking the business planning tool renders the planning interface 410 on a GUI 400 of a computer as shown in FIG. 4. In the given example the planning interface 410 includes a panel 415 representing “Plans and Scenarios” and another panel 420 representing “New Plan.” The Plans and Scenarios panel 415 includes tabs 421, 422, 423, 424 for editing, adding, duplicating, or deleting a plan. Further, the Plans and Scenarios panel 415 includes a table having a first column 426 providing business related attributes, a second column 427 providing description of the information corresponding to the business related attributes, a third column 428 providing a status of the business information rendering process, a fourth column 429 providing details of the contributor, a fifth column 430 providing a cycle period for which the business information is collected, and a sixth column 431 providing a date of modification of the business information. If a contributor associated with the computer wants to submit a new plan, the contributor may select the “New” tab 422 provided on the Plans and Scenarios panel 415. Selecting the “New” tab 422 may in turn provide options 425 “New Plan” and “New Scenario.” The contributor may then select “New Plan” from options 425 in order to submit business information relating to a new plan. The business planning tool then renders the “New Plan” panel 420 on the planning interface 410. The New Plan panel 420 includes fields for importing the business data and fields for providing a description of the business data and the contributor of such business data. Further, the New Plan panel 420 includes fields for specifying the cycle period for which the business information is collected and the data import period. Once the business information is imported into the planning tool from another location within the system, the contributor may save and close the application using the tabs 445. Further, the planning interface may include “Planning Templates” tab 435 for accessing one or more planning templates as shown in FIG. 3. The planning interface 410 may also provide “What-if” tab 440 for invoking prognostic scenarios. The contributor may then provide the business information relating to the prognostic scenarios by accessing the planning template and directly entering the business data into the template or by importing a document having business information by selecting the “New Scenario” from options 425.

In another embodiment, the contributor may edit an already existing report/document/plan from the planning tool instead of adding a new plan. As shown in the FIG. 4, a contributor may provide the required business information by selecting one of the plans already stored in the planning tool and use the edit tab 421 to open an existing plan, update the business data provided in the plan and save the changes. The planning tool may then consolidate the received business information into a standard format and generate a business report. Further, an optimal consensus plan may be proposed by the planning tool based on the received business information and business objectives using heuristic methods applied to past statistical data recorded in the system.

Some embodiments of the invention may include the above-described methods being written as one or more software components. These components, and the functionality associated with each, may be used by client, server, distributed, or peer computer systems. These components may be written in a computer language corresponding to one or more programming languages such as, functional, declarative, procedural, object-oriented, lower level languages and the like. They may be linked to other components via various application programming interfaces and then compiled into one complete application for a server or a client. Alternatively, the components maybe implemented in server and client applications. Further, these components may be linked together via various distributed programming protocols. Some example embodiments of the invention may include remote procedure calls being used to implement one or more of these components across a distributed programming environment. For example, a logic level may reside on a first computer system that is remotely located from a second computer system containing an interface level (e.g., a graphical user interface). These first and second computer systems can be configured in a server-client, peer-to-peer, or some other configuration. The clients can vary in complexity from mobile and handheld devices, to thin clients and on to thick clients or even other servers.

The above-illustrated software components are tangibly stored on a computer readable storage medium as instructions. The term “computer readable storage medium” should be taken to include a single medium or multiple media that stores one or more sets of instructions. The term “computer readable storage medium” should be taken to include any physical article that is capable of undergoing a set of physical changes to physically store, encode, or otherwise carry a set of instructions for execution by a computer system which causes the computer system to perform any of the methods or process steps described, represented, or illustrated herein. Examples of computer readable storage media include, but are not limited to: magnetic media, such as hard disks, floppy disks, and magnetic tape; optical media such as CD-ROMs, DVDs and holographic devices; magneto-optical media; and hardware devices that are specially configured to store and execute, such as application-specific integrated circuits (“ASICs”), programmable logic devices (“PLDs”) and ROM and RAM devices. Examples of computer readable instructions include machine code, such as produced by a compiler, and files containing higher-level code that are executed by a computer using an interpreter. For example, an embodiment of the invention may be implemented using Java, C++, or other object-oriented programming language and development tools. Another embodiment of the invention may be implemented in hard-wired circuitry in place of, or in combination with machine readable software instructions.

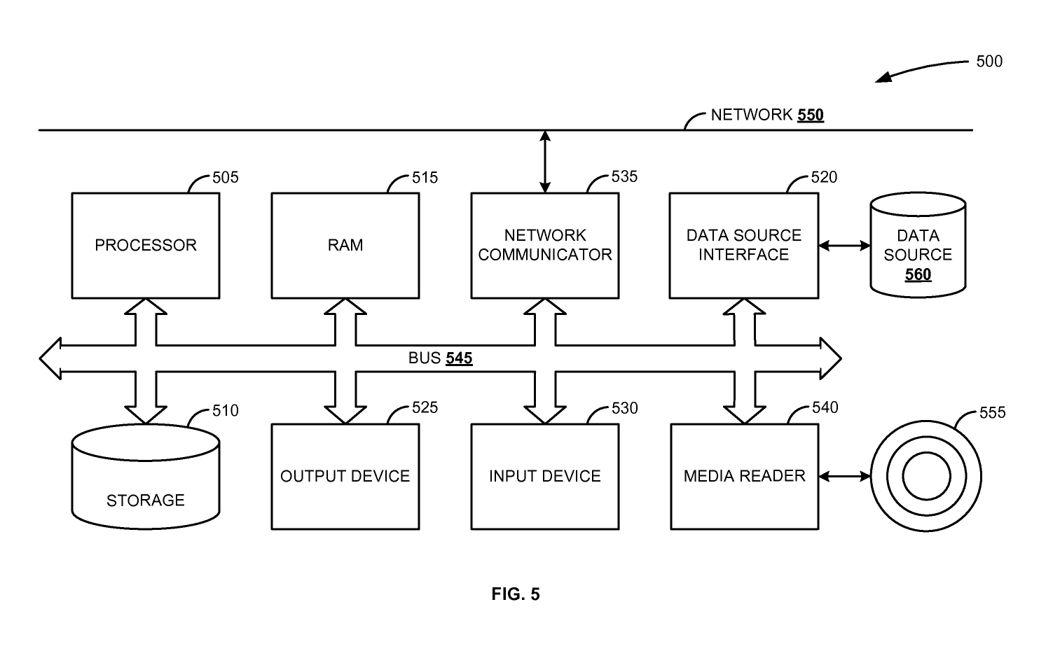

FIG. 5 is a block diagram of an exemplary computer system 500. The computer system 500 includes a processor 505 that executes software instructions or code stored on a computer readable storage medium 555 to perform the above-illustrated methods of the invention. The computer system 500 includes a media reader 540 to read the instructions from the computer readable storage medium 555 and store the instructions in storage 510 or in random access memory (RAM) 515. The storage 510 provides a large space for keeping static data where at least some instructions could be stored for later execution. The stored instructions may be further compiled to generate other representations of the instructions and dynamically stored in the RAM 515. The processor 505 reads instructions from the RAM 515 and performs actions as instructed. According to one embodiment of the invention, the computer system 500 further includes an output device 525 (e.g., a display) to provide at least some of the results of the execution as output including, but not limited to, visual information to users and an input device 530 to provide a user or another device with means for entering data and/or otherwise interact with the computer system 500. Each of these output devices 525 and input devices 530 could be joined by one or more additional peripherals to further expand the capabilities of the computer system 500. A network communicator 535 may be provided to connect the computer system 500 to a network 550 and in turn to other devices connected to the network 550 including other clients, servers, data stores, and interfaces, for instance. The modules of the computer system 500 are interconnected via a bus 545. Computer system 500 includes a data source interface 520 to access data source 560. The data source 560 can be accessed via one or more abstraction layers implemented in hardware or software. For example, the data source 560 may be accessed by network 550. In some embodiments the data source 560 may be accessed via an abstraction layer, such as, a semantic layer.

A data source is an information resource. Data sources include sources of data that enable data storage and retrieval. Data sources may include databases, such as, relational, transactional, hierarchical, multi-dimensional (e.g., OLAP), object oriented databases, and the like. Further data sources include tabular data (e.g., spreadsheets, delimited text files), data tagged with a markup language (e.g., XML data), transactional data, unstructured data (e.g., text files, screen scrapings), hierarchical data (e.g., data in a file system, XML data), files, a plurality of reports, and any other data source accessible through an established protocol, such as, Open DataBase Connectivity (ODBC), produced by an underlying software system (e.g., ERP system), and the like. Data sources may also include a data source where the data is not tangibly stored or otherwise ephemeral such as data streams, broadcast data, and the like. These data sources can include associated data foundations, semantic layers, management systems, security systems and so on.

In the above description, numerous specific details are set forth to provide a thorough understanding of embodiments of the invention. One skilled in the relevant art will recognize, however that the invention can be practiced without one or more of the specific details or with other methods, components, techniques, etc. In other instances, well-known operations or structures are not shown or described in details to avoid obscuring aspects of the invention.

Although the processes illustrated and described herein include series of steps, it will be appreciated that the different embodiments of the present invention are not limited by the illustrated ordering of steps, as some steps may occur in different orders, some concurrently with other steps apart from that shown and described herein. In addition, not all illustrated steps may be required to implement a methodology in accordance with the present invention. Moreover, it will be appreciated that the processes may be implemented in association with the apparatus and systems illustrated and described herein as well as in association with other systems not illustrated.

The above descriptions and illustrations of embodiments of the invention, including what is described in the Abstract, is not intended to be exhaustive or to limit the invention to the precise forms disclosed. While specific embodiments of, and examples for, the invention are described herein for illustrative purposes, various equivalent modifications are possible within the scope of the invention, as those skilled in the relevant art will recognize. These modifications can be made to the invention in light of the above detailed description. Rather, the scope of the invention is to be determined by the following claims, which are to be interpreted in accordance with established doctrines of claim construction.

1. A computer implemented method for facilitating business planning and operations in an integrated system, the method comprising:
receiving one or more criteria defined as a planning trigger;
mapping the one or more criteria to an action plan, wherein the action plan specifies business data required for business planning and identifies one or more contributors of the business data;
actuating the planning trigger in response to recording at least one criterion of the one or more criteria in the integrated system;
a processor of the computer, invoking the action plan corresponding to the at least one criterion, in response to the actuation of the planning trigger;
the processor, notifying the invoked action plan to the one or more contributors identified in the action plan;
the processor, receiving business data specified in the action plan from the one or more contributors, wherein the business data pertains to current business operations; and
the processor, extrapolating the received business data to determine extrapolated business data for one or more prognostic scenarios.

2. The method of claim 1, wherein the prognostic scenarios are defined based on the recorded at least one criterion.

3. The method of claim 1, further comprising proposing an optimal consensus plan based on applying heuristic algorithms to the received business data, wherein the optimal consensus plan aligns with business objectives recorded in the system.

4. The method of claim 1, wherein the one or more criteria include at least one of: a scheduled business operations review, strategy planning, business report review, goal setting meeting, inventory control, production control, supplier evaluation, material requirements planning, marketing promotions planning, demand forecast, sales forecast, revenue planning, resources planning, financial forecast, and socio-economic developments.

5. The method of claim 1, wherein mapping the one or more criteria to an action plan comprises assigning a customized plan of action to each of the one or more criteria.

6. The method of claim 5, wherein the customized action plan comprises attributes specific to each of the one or more contributors, wherein the customized action plan includes one or more of: a list of contributors of business data and associated roles, particulars of business data required from each of the contributors, a defined format for rendering business data, a defined timeline for providing business data by the contributors, and a meeting agenda.

7. The method of claim 1, wherein notifying the invoked action plan to one or more contributors identified in the action plan comprises electronically communicating the invoked action plan to one or more contributors specified in the invoked action plan.

8. The method of claim 1, wherein the action plan includes instructions comprising a set of parameters mapped to a business operation pertaining to the one or more contributors.

9. The method of claim 1, wherein receiving business data specified in the invoked action plan from the one or more contributors comprises receiving data relating to business transactions associated with a business operation pertaining to each of the one or more contributors.

10. The method of claim 1, further comprising reformatting the business data received from the one or more contributors into a standard format and consolidating the reformatted business data.

11. The method of claim 1, wherein extrapolating the received business data to determine extrapolated business data for one or more prognostic scenarios comprises estimating a set of values for the one or more prognostic scenarios based on the received business data and historical data.

12. The method of claim 1, wherein the one or more prognostic scenarios include an optimistic scenario, a pessimistic scenario, a realistic scenario, a best case scenario, and a worst case scenario, relative to the recorded at least one criterion.

13. The method of claim 1, wherein notifying the invoked action plan to one or more contributors comprises sending a customized business information collection template for receiving business information to the one or more contributors.

14. An article of manufacture, comprising:
a non-transitory computer readable storage medium having instructions which when executed by a computer causes the computer to:
receive one or more criteria defined as a planning trigger;
map the one or more criteria to an action plan, wherein the action plan specifies business data required for business planning and identifies one or more contributors of the business data;
actuate the planning trigger in response to recording at least one criterion of the one or more criteria in the integrated system;
invoke the action plan corresponding to the at least one criterion, in response to the actuation of the planning trigger;
notify the invoked action plan to the one or more contributors identified in the action plan;
receive business data specified in the action plan from the one or more contributors, wherein the business data pertains to current business operations; and
extrapolate the received business data to determine extrapolated business data for one or more prognostic scenarios.

15. The article of manufacture in claim 14, wherein the invoked action plan comprises attributes customized according to the one or more contributors.

16. The article of manufacture in claim 14, wherein the one or more prognostic scenarios are defined based on the at least one criterion.

17. An integrated system operating in a communication network, the system comprising:
one or more data source systems; and
a computer communicatively coupled to the data source systems, comprising a memory to store a program code, and a processor to execute the program code to:
receive one or more criteria defined as a planning trigger;
map the one or more criteria to an action plan, wherein the action plan specifies business data required for business planning and identifies one or more contributors of the business data;
actuate the planning trigger in response to recording at least one criterion of the one or more criteria in the integrated system;
invoke the action plan corresponding to the at least one criterion, in response to the actuation of the planning trigger;
notify the invoked action plan to the one or more contributors identified in the action plan;
receive business data specified in the action plan from the one or more contributors, wherein the business data pertains to current business operations; and
extrapolate the received business data to determine extrapolated business data for one or more prognostic scenarios.

18. The system of claim 17, wherein the one or more contributors include automated database systems, business personnel, subject matter experts, and data entry personnel.

19. The system of claim 17, wherein the integrated system is an Enterprise Resource Planning (ERP) system having one or more business modules integrated over the communication network.

20. The system of claim 17, wherein the one or more data source system includes at least one of a web service, a data warehouse, an integrated ERP system, external feed from market research systems, and external news feeds.
